(19) United States
(12) Patent Application Publication
(10) Pub. No.: US 2026/0044302 A1
(43) Pub. Date: Feb. 12, 2026

(54) IMAGE DISPLAY METHOD, IMAGE DISPLAY SYSTEM, AND NON-TRANSITORY COMPUTER-READABLE STORAGE MEDIUM STORING PROGRAM

(71) Applicant: SEIKO EPSON CORPORATION, Tokyo (JP)

(72) Inventors: Eita YAMAKI, MATSUMOTO-SHI (JP); Kazuyuki IINUMA, AZUMINO-SHI (JP)

(21) Appl. No.: 19/293,064

(22) Filed: Aug. 7, 2025

(30) Foreign Application Priority Data
Aug. 9, 2024 (JP) 2024-133922

(51) Int. Cl. G06F 3/16; G06F 3/01; H04R 5/02

(52) U.S. Cl. CPC G06F 3/16; G06F 3/011; H04R 5/02; H04R 2499/15

(57) ABSTRACT

A sound emission device that emits a sound, display devices that display a display image, and a control device that determines whether a state of a user viewing the displayed display image has changed from a first state to a second state different from the first state based on output from a sensor that detects the user are provided, and when the control device determines that the state has changed to the second state, the display devices change a display mode of the display image from a first display mode to a second display mode different from the first display mode.

The present application is based on, and claims priority from JP Application Serial Number 2024-133922, filed Aug. 9, 2024, the disclosure of which is hereby incorporated by reference herein in its entirety.

### BACKGROUND

### 1. Technical Field The present disclosure relates to an image display method, an image display system, and a non-transitory computer-readable storage medium storing a program.

### 2. Related Art

In a system for displaying a video, a technique of changing a video in accordance with a motion of a user on a display screen in order to give a sense of immersion and a sense of presence to the user is known (for example, see JP-A-2019-219820). Specifically, this technique is, in the system for displaying a two-dimensional video from a camera position on the display screen, to move the camera position and causes an object to appear in the video according to the position of the user on the display screen.

JP-A-2019-219820 is an example of the related art.

However, in the technique, a trigger for changing the video is an action of the user who views the video. That is, unless the user moves their position or the like, the process does not proceed to a step of providing the user with a sense of immersion or presence, that is, a step of causing an object to appear in the video. In other words, since the object does not appear unless the user consciously moves, the sense of immersion is lost in this light, and the sense of presence is reduced.

### SUMMARY

An image display method according to an aspect of the present disclosure includes emitting a sound by a sound emission device, determining whether a state of a user has changed from a first state to a second state different from the first state based on output from a sensor that detects the user by a control device, and changing a display mode of a display image from a first display mode to a second display mode different from the first display mode by a display device that displays the display image when determining that the state has changed to the second state by the control device.

An image display system according to an aspect of the present disclosure includes a sound emission device that emits a sound, a display device that displays a display image, and a control device that determines whether a state of a user viewing the display image displayed by the display device has changed from a first state to a second state different from the first state based on output from a sensor that detects the user, wherein the control device changes a display mode of the display image by the display device from a first display mode to a second display mode different from the first display mode when determining that the state has changed to the second state.

A non-transitory computer-readable storage medium storing a program according to an aspect of the present disclosure causes a computer that controls a sound emission device that emits a sound and a display device that displays a display image to execute instructing the sound emission device to emit the sound, determining whether a state of a user viewing the display image has changed from a first state to a second state different from the first state based on output from a sensor that detects the user, and changing a display mode of the display image by the display device from a first display mode to a second display mode different from the first display mode when determining that the state has changed to the second state.

### BRIEF DESCRIPTION OF THE DRAWINGS

FIG. 1 shows a configuration of a video display system to which a video display method according to an embodiment is applied.

FIG. 2 is a functional block diagram constructed in a control device in the video display system.

FIG. 3 shows a configuration of video and audio data used in the video display system.

FIG. 4 shows an arrangement example of elements in the video display system.

FIG. 5 is a flowchart showing an operation of the control device.

FIG. 6 mainly shows an example of video display in the video display system.

FIG. 7 shows an example of an operation in the video display system.

FIG. 8 shows an example of the operation in the video display system.

FIG. 9 shows an example of the operation in the video display system.

FIG. 10 shows an example of the operation in the video display system.

### DESCRIPTION OF EMBODIMENTS

Hereinafter, a display method according to an embodiment will be described with reference to the drawings. Note that, in the drawings, dimensions and scales of the respective parts are appropriately made different from real ones. Further, the following embodiment is a preferable specific example and therefore various technically preferable limitations are imposed thereon, however, the scope of the present disclosure is not limited to the embodiment unless there is a description that the present disclosure is limited thereto in particular in the following description.

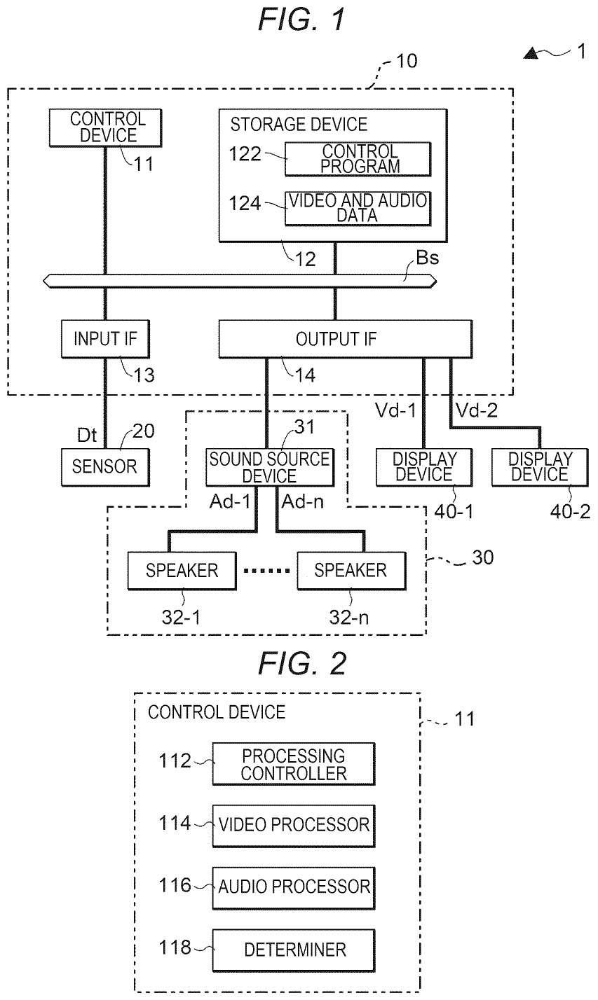

FIG. 1 is a block diagram illustrating a configuration of a video display system 1 that implements a video display method according to an embodiment. Schematically, when an experiencing person is viewing a video together with a BGM, the video display system 1 emits a sound (hereinafter, referred to as a “specific sound”) different from the BGM at a certain timing, and when the experiencing person becomes aware of the specific sound, changes the mode of the video displayed so far.

Since the mode of the video changes with the awareness of the experiencing person as a trigger, a feeling that the change in the video occurs not by the intention of a video creator, but due to his/her own action can be provided to the experiencing person.

As illustrated in the drawing, the video display system 1 includes a computer 10, a sensor 20, a sound emission device 30, speakers 32-1 to 32-n, and display devices 40-1 and 40-2. The video display system 1 constructs a video space by these elements.

The computer 10 controls each unit in the video display system 1. The computer 10 includes a control device 11, a storage device 12, an input IF (interface) 13, and an output IF 14. These devices are electrically coupled to one another via, for example, a bus Bs.

The control device 11 includes one or more processing circuits such as a CPU (Central Processing Unit), and performs integrated control of the elements of the computer 10. Note that the control device 11 may include a circuit such as a DSP (Digital Signal Processor) or an ASIC (Application Specific Integrated Circuit) besides the CPU.

The storage device 12 is, for example, one or more memories including a known recording medium such as a magnetic recording medium or a semiconductor recording medium. The storage device 12 stores a control program 122 for the control device 11 to control each unit, and video and audio data 124 including video data and audio data. The video data is an example of display image data, and video is an example of display image.

The storage device 12 may include a combination of a plurality of types of recording media. As the storage device 12, a portable recording medium that can be attached to and detached from the computer 10 or an external recording medium with which the computer 10 can communicate via a network, for example, an online storage may be used.

The input IF 13 is a device for inputting captured image data Dt from the sensor 20. The output IF 14 is a device for supplying audio data to the sound emission device 30, supplying a video signal Vd-1 to the display device 40-1, and supplying a video signal Vd-2 to the display device 40-2.

The sensor 20 is, for example, an image capturing device, and captures an image of the experiencing person who views the video and audio by the video display system 1, and supplies the captured image data Dt representing the image capturing result to the computer 10. In the present embodiment, the sensor 20 includes the single image capturing device for simplification of the description, however, may include two or more sensors. Another sensor, for example, an infrared sensor, an acoustic wave sensor, a range sensor, a contact sensor, a combination of these sensors, or a sensor module with a combination of these sensors may be used.

The experiencing person refers to a person who experiences/views video and audio by the video display system 1. Hereinafter, the experiencing person is referred to as a user for convenience.

The sound emission device 30 includes a sound source device 31 and the speakers 32-1 to 32-n.

The sound source device 31 applies a predetermined effect to (performs processing on) the audio data supplied via the output IF 14, converts the audio data into n-channel analog audio signals Ad-1 to Ad-n, amplifies the audio signals, and sequentially supplies the audio signals to the speakers 32-1 to 32-n.

Examples of the effect applied by the sound source device 31 to the audio data include a stereophonic effect (surround processing) of providing three-dimensional sound direction, distance, and spread to a background sound based on BGM data in the audio data, and an effect (panning processing) of fixing or moving a sound image position of a specific sound based on specific sound data.

In the panning processing, position information of the user (strictly speaking, information indicating a direction and a position in which the head of the user faces) is required, and such position information of the user can be acquired by analyzing the captured image data Dt by the sensor 20. Hereinafter, in the panning processing, the user position information acquired by analyzing the captured image data Dt is used.

The speakers 32-1 to 32-n are sound emitting devices that sequentially converts the audio signals Ad-1 to Ad-n into audio as physical vibration and outputs the audio. FIG. 1 shows n speakers 32-1 to 32-n provided for each channel.

When the sound image position is not changed and the stereophonic effect is not applied, the number of speakers may be one.

The display device 40-1 is specifically a projector, and projects a video based on the video signal Vd-1 supplied from the computer 10. Similarly, the display device 40-2 projects a video based on the video signal Vd-2.

Although two display devices 40-1 and 40-2 are illustrated in the drawing for convenience, the number of display devices may be one or three or more. Further, the display devices 40-1 and 40-2 are not limited to the projectors, but may be direct-view-type panel display devices.

FIG. 2 is a block diagram illustrating a functional configuration constructed by the control device 11 of the computer 10 executing the control program 122 stored in the storage device 12.

As illustrated in the drawing, the control device 11 functions as a processing controller 112, a video processor 114, an audio processor 116, and a determiner 118.

The processing controller 112 starts reading the video and audio data 124 from the storage device 12 by a predetermined operation or the like, and controls the video processor 114, the audio processor 116, and the determiner 118.

The video processor 114 generates the video signals Vd-1 and Vd-2 based on the video data in the video and audio data 124 read by the processing controller 112 under the control of the processing controller 112. The video signal Vd-1 generated by the video processor 114 is supplied to the display device 40-1 via the output IF 14, and the video signal Vd-2 is supplied to the display device 40-2 via the output IF 14.

The audio processor 116 detects whether the audio data represents sound or silence in the video and audio data 124 read by the processing controller 112, notifies the processing controller 112 of the detection result, and outputs the audio data representing sound.

The determiner 118 analyzes the captured image data Dt captured by the sensor 20 in accordance with an instruction from the processing controller 112, and determines whether there is a change in the behavior of the user. The behavior of the user is specifically an orientation of a face or a body, a facial expression, a line-of-sight direction, a standing position, or the like. The temporal change rates of the behaviors may be considered for the change in behavior. Specifically, when the change rate of the behavior is less than a threshold, a determination that there is no change in the behavior may be made.

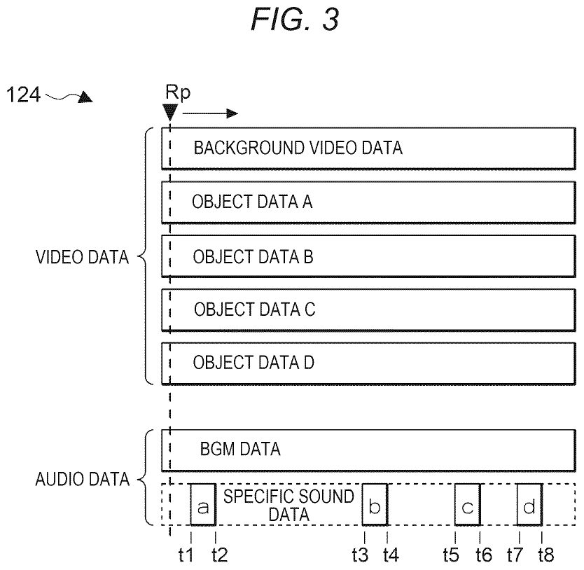

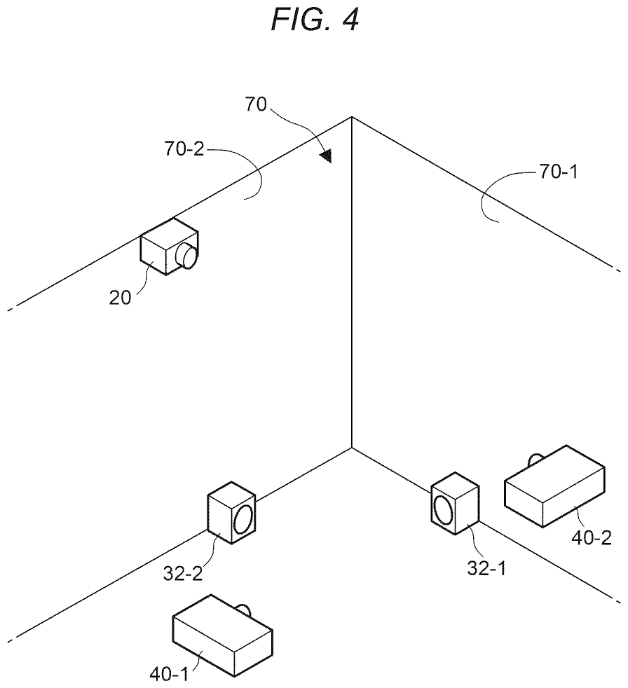

FIG. 3 shows an example of the video and audio data 124. In this example, both the video data and the audio data constituting the video and audio data 124 are track data in which data obtained by sampling video/audio at a constant cycle is arranged in time series. Therefore, the track data is read at a point Rp for each sampling cycle, thereby reproducing the video or audio in synchronization.

In the present embodiment, the display devices 40-1 and 40-2 display a video in which an object is superimposed on a background video. The video data includes background video data representing the background video and object data A to D respectively representing objects.

The background video data is video data representing a background video of sea, sky, space, or the like, and in the present embodiment, an undersea video containing seaweeds, rocks, bubbles, or the like is used as the background video.

The object data A to D are data representing objects such as fish, birds, and animals superimposed on the background video, and the objects include real objects, virtual objects (CG), and the like, but do not include the backgrounds. In the present embodiment, different groups of fish are used as the object data A to D.

The audio data includes the BGM data and the specific sound data.

The BGM data is data representing music and environmental sound played to create an atmosphere when a video is displayed.

The specific sound data is data representing a sound for giving a certain type of awareness to the user viewing the video together with the BGM. The sound that gives awareness is not limited to natural sounds such as rain sound, sound, and lightning, but may be electronic sounds such as noise.

When an operator or an external device gives an instruction to start display, the processing controller 112 starts reading the video and audio data 124 as track data. Specifically, the processing controller 112 advances the point Rp in the rightward direction in the drawing at a constant speed, and continues to read the video data and the audio data at the reading point designated by the point Rp.

The processing controller 112 supplies the video data in the read video and audio data 124 to the video processor 114 and supplies the audio data to the audio processor 126.

The video processor 114 generates a video in which an object based on the object data A to D is superimposed on a background video based on the background video data in the video data. Note that, the video processor 114 superimposes not all of the object data A to D read in synchronization with the background video data, but some of the object data A to D that satisfies a condition, which will be described later, on the background video as the video data Vd-1 and Vd-2.

In the audio data, the specific sound data is sound data divided by data a, b, c, and d. Specifically, the data a, b, c, and d are data representing sound only during the periods of timings t1 to t2, t3 to t4, t5 to t6, and t7 to t8 in order, and are data representing silence during the other periods indicated by the broken lines. The data a, b, c, and d may be unified to represent the same type of sound (for example, sound of bubbles) or may represent different types of sound (for example, sound of bubbles, sound of waves, and noise). The specific sound is preferably a sound of a type related to an object to be subsequently displayed.

FIG. 4 shows an arrangement example of the respective elements in the video display system 1. Although the respective elements in the video display system 1 are provided in an audiovisual room 70, in the drawing, part of the ceiling, the wall surfaces, and the like in the audiovisual room 70 are omitted and only the speakers 32-1 and 32-2 among the speakers 32-1 to 32-n are illustrated in order to clearly describe the arrangement example.

The display device 40-1 projects a video on a wall surface 70-1 in the audiovisual room 70. The display device 40-2 projects a video on a wall surface 70-2 in contact with the wall surface 70-1 in the audiovisual room 70. The sensor 20 is attached to, for example, the wall surface 70-2 and captures an image of the user omitted in FIG. 4. The video is, for example, a still image, a moving image, or a content with mixture of the images.

The speaker 32-1 is attached to, for example, the wall surface 70-1, and the speaker 32-2 is attached to, for example, the wall surface 70-2. The sound emission directions of the speakers 32-1 and 32-2 are, for example, toward the center of the audiovisual room 70 in a plan view. The plan view refers to viewing the floor surface from the ceiling of the audiovisual room 70.

In this example, the video is projected on the wall surfaces 70-1 and 70-2, but the projection surface of the video may be the entire wall surface of the audiovisual room 70, or may include the ceiling and the floor surface.

Next, an operation of the video display system 1, specifically, an operation of each unit by the control device 11 in the computer 10 will be described.

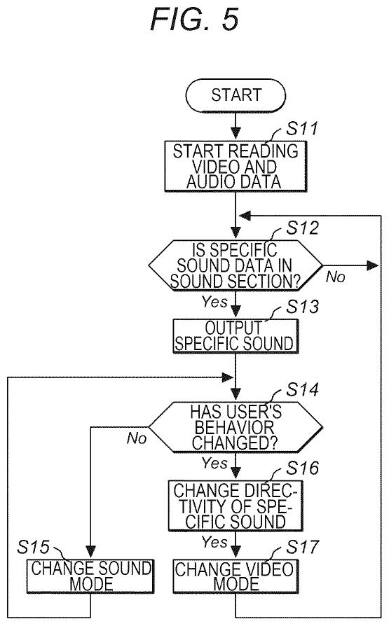

FIG. 5 is a flowchart showing the operation of each unit constructed by the control device 11.

As described above, when the instruction to start display is given, the processing controller 112 starts reading the video and audio data 124 (step S11).

The processing controller 112 transfers the video data of the read video and audio data 124 to the video processor 114, and transfers the audio data to the audio processor 116. The video processor 114 generates the video signals Vd-1 and Vd-2 based on the transferred video data, and the audio processor 116 generates the audio signals Ad-1 to Ad-n based on the transferred audio data.

The display device 40-1 projects a video based on the video signal Vd-1 onto the wall surface 70-1, and the display device 40-2 projects a video based on the video signal Vd-2 onto the wall surface 70-2. The speakers 32-1 to 32-n sequentially emits sounds based on the audio signals Ad-1 to Ad-n.

As shown in FIG. 3, the specific sound data represents silence immediately after the start of reading the video and audio data 124. The processing controller 112 causes the video processor 114 not to display the objects based on the object data A to D.

Therefore, the display devices 40-1 and 40-2 display only the background video, and the speakers 32-1 to 32-n emit only the BGM.

Then, the processing controller 112 causes the audio processor 116 to determine whether the specific sound data in the audio data represents sound (step S12). When the notification from the audio processor 116 indicates silence (when the determination result in step S12 is “No”), the processing controller 112 returns the processing procedure to step S12. That is, when the specific sound data represents silence, the processing procedure enters a standby state in step S12.

When the notification from the audio processor 116 indicates sound (when the determination result in step S12 is “Yes”), the processing controller 112 supplies the specific sound data of sound together with the BGM data to the sound source device 31 (step S13). Thus, the speakers 32-1 to 32-n emit a specific sound together with the BGM. Since the purpose of the specific sound is to make the user aware, the initial volume is set to be low.

The processing controller 112 instructs the sound source device 31 to set the sound image position of the specific sound to a position different from the position in the direction in which the head of the user faces. For example, when the user faces the wall surface 70-1, the processing controller 112 instructs the sound source device 31 to set the boundary between the wall surfaces 70-1 and 70-2 as the sound image position of the specific sound.

Therefore, the specific sound has directivity (an example of first directivity) in a direction from the sound image position toward the user.

When the user becomes aware of the emission of the specific sound, a change may appear in the behavior such as turning the head or the body or moving the line of sight in a direction in which the emitted sound is emitted. The processing controller 112 grasps the presence or absence of such a behavior change by a notification from the determiner 118.

That is, the processing controller 112 determines the presence or absence of the behavior change by the notification from the determiner 118 (step S14).

When the notification of the determiner 118 indicates that there is no change in the behavior of the user (when the determination result in step S14 is “No”), the processing controller 112 instructs the audio processor 116 to change the mode of the specific sound (step S15). In the present embodiment, the instruction to change the mode of the specific sound is an instruction to increase the volume of the specific sound. Then, the processing controller 112 returns the processing procedure to step S14.

When there is no change in the behavior of the user after the processing procedure returns from step S15 to step S14, the processing procedure repeats steps S14 and S15. Therefore, the volume of the specific sound gradually increases, and the user eventually becomes aware of the specific sound and changes the behavior. However, when a state with no change in the behavior of the user continues for a predetermined time even after the sound mode is changed, the emission of the specific sound may be stopped, the processing procedure may be returned to step S12, and the standby state may be set until the next specific sound is emitted, though not particularly illustrated.

On the other hand, when the notification of the determiner 118 indicates that there is a change in the behavior of the user (when the determination result in step S14 is “Yes”), the processing controller 112 instructs the sound source device 31 to set the sound image position of the specific sound to a position different from the position in step S13 (step S16).

For example, when the sound image position of the specific sound is set to the boundary between the wall surfaces 70-1 and 70-2 in step S13, the processing controller 112 instructs the sound source device 31 to change the sound image position to the center position of the wall surface 70-2. Therefore, the specific sound has directivity (an example of second directivity) in a direction from the changed sound image position toward the user.

Then, the processing controller 112 instructs the video processor 114 to change the mode of the video based on the video data (step S17). In the present embodiment, the instruction to change the mode of the video is addition or switching of the video based on the object data. That is, when the video based on the video data is only the background video, an instruction to newly display the video based on the object data to be superimposed on the background video is given, and when the video based on certain object data is already superimposed on the background video and displayed, an instruction to switch to the video based on other object data is given. The switching to the video based on the object data may be performed instantaneously, may be performed while overlapping the videos based on both object data, or may be performed by fading in the video based on the new object data while fading out the video based on the first object data.

After step S17, the processing procedure returns to step S12.

When the reading of the video and audio data 124 temporally reaches the last part, or when an instruction to end the display is given by the operator or the external device, the processing controller 112 ends the display operation.

Next, a specific operation in the video display system 1 will be described.

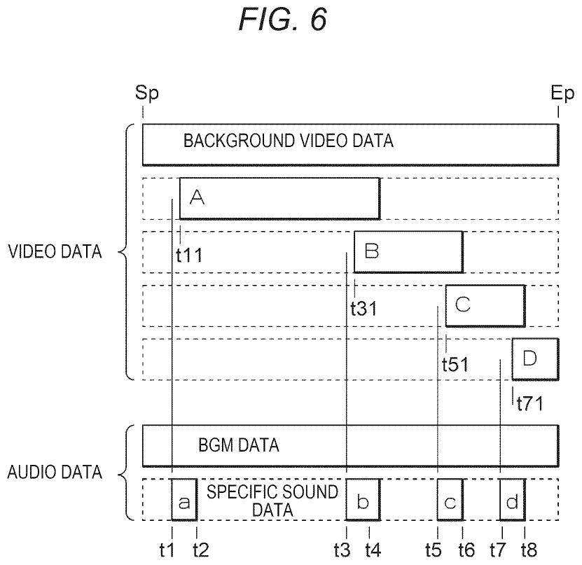

FIG. 6 shows an example of objects superimposed on the background video in the video data.

Since the background video data is read from a start point Sp to an end point Ep, the background video represented by the background video data is continuously reproduced without interruption.

When the timing t1 is reached in the reproduction of the background video, since the specific sound data is in a sound section of the data a, the specific sound is emitted by the reproduction of the data a.

Here, when there is a behavior change of the user at a timing t11 after the timing t1 at which the specific sound based on the data a is emitted, the directivity of the specific sound is changed, and the object based on the object data A is superimposed and displayed on the background video. The object is displayed to fade in, that is, the object is displayed to gradually appear.

In this example, the specific sound stops at the timing t2 when the reproduction of the data a ends.

When the timing t3 is reached in the reproduction of the background video, since the specific sound data is in a sound section of the data b, the specific sound is emitted by the reproduction of the data b.

Here, when there is a behavior change of the user at a timing t31 after the timing t3 at which the specific sound based on the data b is emitted, the directivity of the specific sound is changed, the object based on the object data B is superimposed and displayed on the background video, and the object based on the object data A is deleted.

The object based on the object data B is displayed to fade in, whereas the object based on the object data A is displayed to fade out, that is, the object is displayed to gradually disappear.

Similarly, when the timing t5 is reached, the specific sound is emitted by the reproduction of the data c, and when there is a behavior change of the user at the subsequent timing t51, the directivity of the specific sound is changed, the object based on the object data C is superimposed and displayed on the background video, and the object based on the object data B is deleted.

Similarly, when the timing t7 is reached, the specific sound is emitted by the reproduction of the data d, and when there is a behavior change of the user at the subsequent timing t71, the directivity of the specific sound is changed, and the object based on the object data D is superimposed and displayed on the background video.

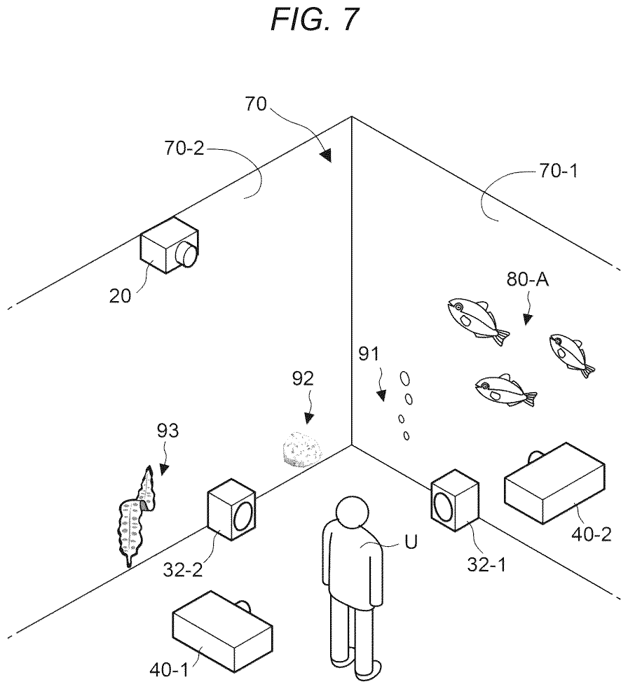

FIGS. 7 to 10 show specific operations in the video display system 1.

FIG. 7 illustrates, for example, a state after the timing t11 and before the timing t3 in FIG. 6, that is, an example in which the object based on the object data A is superimposed and displayed on the background video. Specifically, in the example, the undersea is displayed as a background video on the wall surfaces 70-1 and 70-2, the background video includes bubbles 91, a rock 92, and a seaweed 93, and the example shows a state in which a user U faces the direction toward the wall surface 70-1 in the audiovisual room 70. On the wall surface 70-1, as an example of the object based on the object data A, a school of fish 80-A is superimposed and displayed on the background image.

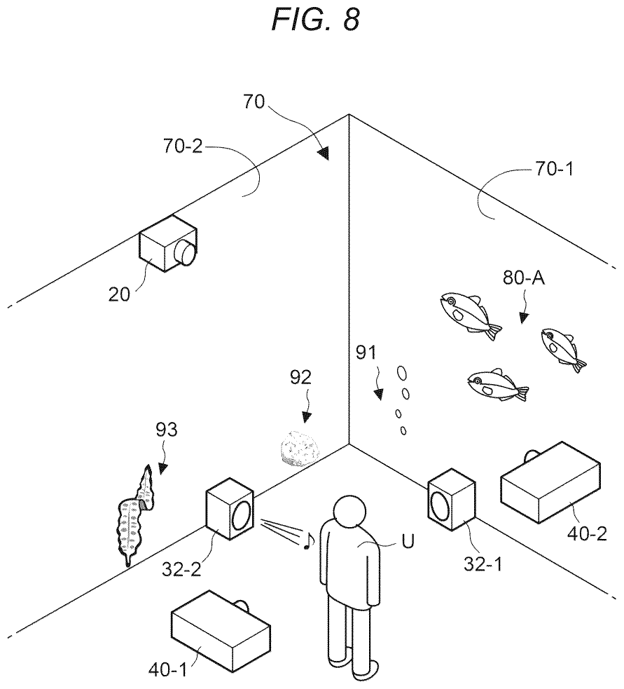

FIG. 8 illustrates a state immediately after the specific sound based on the data b is emitted at the timing t3 in FIG. 6, for example. The sound image position of the specific sound is the position of the speaker 32-1 for convenience. Further, in this state, immediately after the specific sound is emitted, the user U is not aware of the specific sound, and thus there is no behavior change.

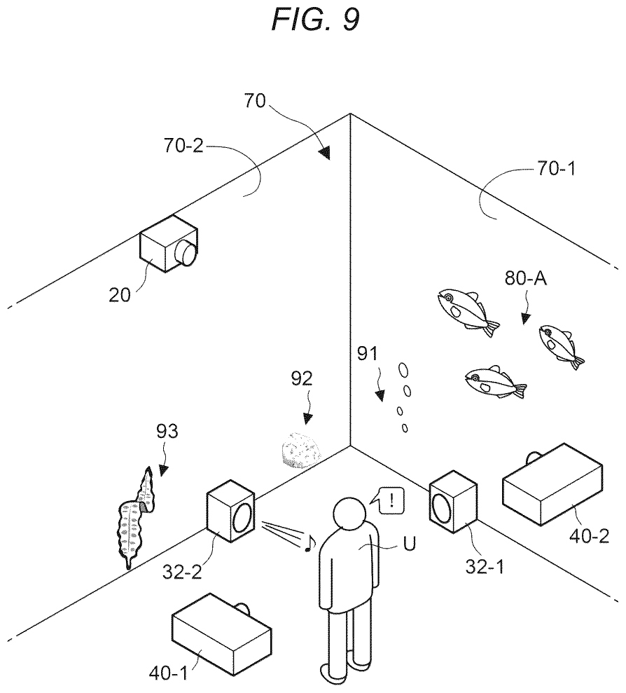

FIG. 9 illustrates a state immediately after the user U becomes aware of the specific sound based on the data b and behaves to direct his/her body toward the emission direction of the specific sound. This drawing shows a state before the change in behavior is determined by the determiner 118.

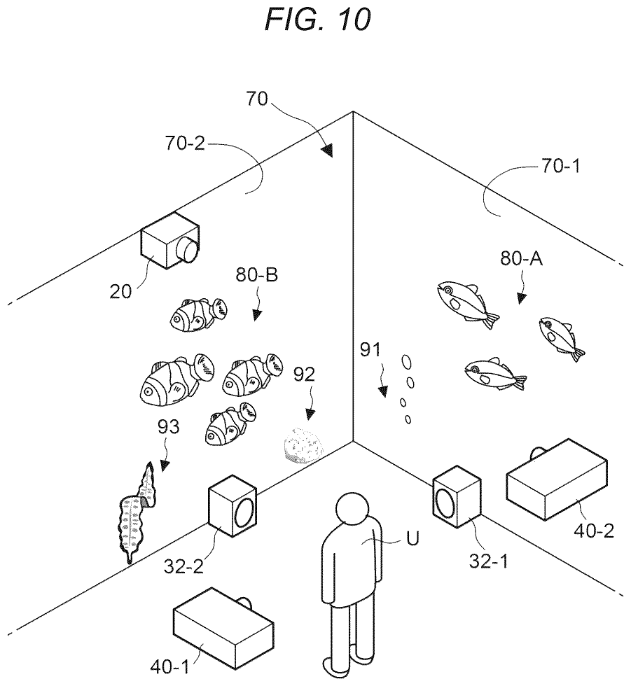

FIG. 10 illustrates a state in which the object based on the object data B is displayed due to the change in behavior. Specifically, in the example, as the object based on the object data B, another school of fish 80-B than the school 80-A is superimposed and displayed on the background video on the wall surface 70-2.

Then, the school 80-A as the object based on the object data A fades out in the above-described manner.

As described above, according to the video display method of the present embodiment, after the specific sound is emitted, the video changes with the change in the behavior of the user as a trigger, and thus the user viewing the video can be provided with a deeper sense of immersion and the sense of presence can be increased. That is, according to the video display method of the present embodiment, the behavior of the user can be changed by the emission of the specific sound. According to the video display method, the video changes when a change in the behavior of the user is detected. Therefore, according to the video display method, the emission of the specific sound creates an opportunity for the user to pay attention to the video, and thus a trigger for the user to actively interfere with the video space can be created.

The video changes with the change in the behavior of the user as the trigger. Conversely, the user can be immersed in the video change without feeling the intention of the video creator. Since the user does not feel the intention of the video creator, the user has a feeling of finding the change in the video by himself/herself, and the development of a new interaction between the change in the video and the user can be expected.

In the present embodiment, since the video changes with a change in the behavior of the user as a trigger, the user concentrates on the video. For this reason, application to indirect treatment or calm down can be expected for a developmentally disabled person with a hyperactive tendency, a mental disordered patient with divergent thinking, and the like.

In the present embodiment, when there is a user who has found a causal relationship between the behavior change of the user and the change in the video, the user estimates that the user's own action affects the video space, and thus the sense of immersion in the video space can be enhanced.

In the above-described embodiment, the specific sound is generated based on the specific sound data reproduced in synchronization with the video data, but for example, the specific sound may be generated according to a predetermined time table, may be generated at regular time intervals, or may be generated at random timing.

In the embodiment, the object to be superimposed on the background video is faded out and the new object is faded in with the change in the behavior of the user who becomes aware of the emission of the specific sound as a trigger, however, the object may be instantaneously switched. The background video may be dynamically switched to another background video.

In the embodiment, it is assumed that there is only one user in the audiovisual room 70, but when there are two or more users, for example, when the behavior of a majority of the users changes, the determination result in step S14 may be made as “Yes”.

The directivity of the specific sound may be changed in a period in which the specific sound is emitted, not fixed. For example, the sound image of the specific sound may be localized on the north side of the audiovisual room 70 and then moved from north to east. In such movement, it is considered that the user behaves to follow the sound image from north to east. Therefore, the determiner 118 can determine whether the user is aware of the movement of the specific sound by detecting the behavior from north to east among the behaviors of the user.

In the embodiment, the mode of the video is changed with the change in the behavior of the user that appears by stimulating the user's auditory sense as a trigger. The stimulus applied to the user may be a sense other than the auditory sense, for example, a visual sense. Specifically, some object may be displayed in the video, or in a partial region, a video different from that of another region may be displayed, and the mode of the video may be changed with a behavior change as awareness of the difference in display as a trigger.

Alternatively, a tactile sense may be used as the stimulus applied to the user. For example, a plurality of actuators may be provided on the floor surface, one or two or more of the plurality of actuators may be vibrated, and the mode of the video may be changed with a behavior change as awareness of the vibration as a trigger. Or, an air wave such as wind, a pressure wave, or a vortex wave may be sent toward the user, and the mode of the video may be changed with a behavior change as awareness of the air wave as a trigger.

An olfactory sense may be used as the stimulus applied to the user. For example, a liquid having a scent may be sprayed, and the mode of the video may be changed with a behavior change as awareness of the scent as a trigger.

The summary of the present disclosure will be appended below.

An image display method according to Appendix 1 includes emitting a sound by a sound emission device, determining whether a state of a user has changed from a first state to a second state different from the first state based on output from a sensor that detects the user by a control device, and changing a display mode of a display image from a first display mode to a second display mode different from the first display mode by a display device that displays the display image when determining that the state has changed to the second state by the control device.

According to the image display method in Appendix 1, the display image changes from the first display mode to the second display mode with the user changing from the first state to the second state as a trigger. For this reason, since the change in the display image occurs not by the intention of a display image creator, but due to the user's own action, the user can be immersed in the viewing of the display image.

Examples of the change of the user from the first state to the second state include changes in the orientation of the face or body of the user, a gesture, a facial expression, a line of sight, a position, and the like. The display image refers to an image displayed by the display device, and includes a still image and a moving image.

In addition, the change in the display mode in the display image refers to not only a change from a state in which some display image is displayed to a state in which another display image is displayed, but also a change from a state in which nothing is displayed to a state in which a new display image is displayed, and a change from a state in which some display image is displayed to a state in which nothing is displayed.

The display image display method in Appendix 2 according to Appendix 1 further includes, by the sound emission device, emitting the sound in a first sound mode in a first period, and emitting the sound in a second sound mode different from the first sound mode in a second period in which the display mode has been changed to the second display mode by the display device. Examples of the mode of the sound include a volume, a pitch, and a tone, and the different mode refers to a state in which one or more of these elements are different.

In the image display method in Appendix 3 according to Appendix 2, the first sound mode is that the sound has a first directivity, and the second sound mode is that the sound has a second directivity different from the first directivity. According to the image display method in Appendix 3, when the directivity of the sound changes, the user can be made aware of the change. The directivity of the sound refers to a direction in which the sound is strongly transmitted, and specifically, the sound is perceived by the user when a sound image position by the sound emission device changes.

The image display method in Appendix 4 according to Appendix 3 further includes changing a display position of an object contained in the display image from a first position in the first period to a second position in the second period by the display device, wherein the second directivity of the sound in the second sound mode has a direction from the second position. According to the image display method in Appendix 4, the display position of the object contained in the display image changes according to the directivity of the sound. A direction corresponding to the second position refers to a direction from the second position or a direction toward the second position.

In the image display method in Appendix 5 according to Appendix 3, the directivity of the sound in the first sound mode has a first direction toward the user, and the directivity of the sound in the second sound mode has a direction different from the first direction.

The image display method in Appendix 6 according to Appendix 1, further includes displaying a display image in a first period by reproduction based on display image data by the display device, and emitting a sound in the first period in synchronization with the reproduction based on the display image data by the sound emission device.

An image display system according to Appendix 7 includes a sound emission device that emits a sound, a display device that displays a display image, and a control device that determines whether a state of a user viewing the display image displayed by the display device has changed from a first state to a second state different from the first state based on output from a sensor that detects the user, wherein the control device changes a display mode of the display image by the display device from a first display mode to a second display mode different from the first display mode when determining that the state has changed to the second state.

According to the image display system in Appendix 7, as is the case of Appendix 1, since the change in the display image occurs not by the intention of a display image creator, but due to the user's own action, the user can be immersed in the viewing of the display image.

A non-transitory computer-readable storage medium storing a program according to Appendix 8 causes a computer that controls a sound emission device that emits a sound and a display device that displays a display image to execute instructing the sound emission device to emit the sound, determining whether a state of a user viewing the display image has changed from a first state to a second state different from the first state based on output from a sensor that detects the user, and changing a display mode of the display image by the display device from a first display mode to a second display mode different from the first display mode when determining that the state has changed to the second state.

According to the program in Appendix 8, as is the case of Appendix 1, since the change in the display image occurs not by the intention of a display image creator, but due to the user's own action, the user can be immersed in the viewing of the display image.

What is claimed is:

1. An image display method comprising:
emitting a sound by a sound emission device;
determining whether a state of a user has changed from a first state to a second state different from the first state based on output from a sensor that detects the user by a control device; and
changing a display mode of a display image from a first display mode to a second display mode different from the first display mode by a display device that displays the display image when determining that the state has changed to the second state by the control device.

2. The image display method according to claim 1, further comprising:
by the sound emission device,
emitting the sound in a first sound mode in a first period; and
emitting the sound in a second sound mode different from the first sound mode in a second period in which the display mode has been changed to the second display mode by the display device.

3. The image display method according to claim 2, wherein
the first sound mode is that the sound has a first directivity, and
the second sound mode is that the sound has a second directivity different from the first directivity.

4. The image display method according to claim 3, further comprising changing a display position of an object contained in the display image from a first position in the first period to a second position in the second period by the display device, wherein
the second directivity of the sound in the second sound mode has a direction from the second position.

5. The image display method according to claim 3, wherein
the directivity of the sound in the first sound mode has a first direction toward the user, and
the directivity of the sound in the second sound mode has a direction different from the first direction.

6. The image display method according to claim 1, further comprising:
displaying a display image in a first period by reproduction based on display image data by the display device; and
emitting a sound in the first period in synchronization with the reproduction based on the display image data by the sound emission device.

7. An image display system comprising:
a sound emission device that emits a sound;
a display device that displays a display image; and
a control device that determines whether a state of a user viewing the display image displayed by the display device has changed from a first state to a second state different from the first state based on output from a sensor that detects the user, wherein
the control device changes a display mode of the display image by the display device from a first display mode to a second display mode different from the first display mode when determining that the state has changed to the second state.

8. A non-transitory computer-readable storage medium storing a program causing a computer that controls a sound emission device that emits a sound and a display device that displays a display image to execute:
instructing the sound emission device to emit the sound;
determining whether a state of a user viewing the display image has changed from a first state to a second state different from the first state based on output from a sensor that detects the user; and
changing a display mode of the display image by the display device from a first display mode to a second display mode different from the first display mode when determining that the state has changed to the second state.
